(19) United States
(12) Patent Application Publication
(10) Pub. No.: US 2025/0362975 A1
(43) Pub. Date: Nov. 27, 2025

(54) EXECUTION HARDWARE DETERMINATION METHOD

(71) Applicant: HITACHI, LTD., Tokyo (JP)

(72) Inventors: Pritam Jaywant Chaudhari, Tokyo (JP); Yoji Ozawa, Tokyo (JP)

(73) Assignee: HITACHI, LTD., Tokyo (JP)

(21) Appl. No.: 19/077,644

(22) Filed: Mar. 12, 2025

(30) Foreign Application Priority Data
May 23, 2024 (JP) 2024-084014

(51) Int. Cl. G06F 9/50

(52) U.S. Cl. CPC G06F 9/5094; G06F 2209/501; G06F 2209/5019; G06F 2209/503; G06F 2209/506

(57) ABSTRACT

Hardware suitable for execution of a neural network model can be selected from the viewpoint of a consumption amount of brown energy. A computer determines execution hardware, which is hardware that executes a neural network model. The execution hardware determination method includes: query reception processing for reading a user query in which a use case of the neural network model; search processing for searching a model database for a standard model, which is a neural network model that satisfies most of the constraint of the candidate hardware and the performance condition; preliminary calculation processing for inputting to an energy prediction model a performance metric of the standard model and the constraint of the candidate hardware based on the user query; and determination processing for determining the execution hardware that executes a work load which is a proportion of renewable energy to energy supplied to the candidate hardware.

### BACKGROUND OF THE INVENTION

### 1. Field of the Invention

The present invention relates to an execution hardware determination method.

### 2. Description of the Related Art

It is desired that a neural network model be optimized depending on hardware that executes the neural network model. PTL 1 discloses a method of training and optimizing a machine-learning model, the method including the steps of: selecting a machine-learning model for optimization; generating a set of derived variants of the machine-learning model; quantizing, for each of the derived variants, numerical parameters within the derived variant; and compiling the derived variant thereby producing a runtime artifact; evaluating the set of derived variants for latency within a target hardware architecture, thereby identifying one or more derived variants that satisfy a latency criterion; training only the one or more variants; and evaluating one or more trained variants for accuracy.

### PATENT LITERATURE

[PTL 1] U.S. Patent Application Publication No. 2023/0297835

### SUMMARY OF THE INVENTION

In the invention disclosed in PTL 1, hardware suitable for execution of a neural network model cannot be selected from the viewpoint of a consumption amount of brown energy.

An execution hardware determination method according to a first aspect of the present invention is an execution hardware determination method for a computer to determine execution hardware, which is hardware that executes a neural network model, including: query reception processing for reading a user query in which a use case of the neural network model, a performance condition, and a constraint of candidate hardware, which is a candidate of the execution hardware, are written; search processing for searching a model database for a standard model, which is a neural network model that satisfies most of the constraint of the candidate hardware and the performance condition; preliminary calculation processing for inputting to an energy prediction model a performance metric of the standard model and the constraint of the candidate hardware, based on the user query, and obtaining an energy consumption amount in the candidate hardware; and determination processing for determining the execution hardware that executes a work load corresponding to the user query on the basis of the obtained energy consumption amount and a green power ratio, which is a proportion of renewable energy to energy supplied to the candidate hardware.

According to the present invention, hardware suitable for execution of a neural network model can be selected from the viewpoint of a consumption amount of brown energy.

### BRIEF DESCRIPTION OF THE DRAWINGS

FIG. 1 is an entire configuration diagram including an execution hardware determination system;

FIG. 2 is a configuration diagram of the execution hardware determination system;

FIG. 3 is a diagram illustrating an example of a user query;

FIG. 4 is a diagram illustrating an example of a model database;

FIG. 5 is a diagram illustrating an example of a green power ratio table;

FIG. 6 is a diagram illustrating a correlation between a program and a neural network model;

FIG. 7 is a flowchart illustrating a method for generating a prediction model;

FIG. 8 is a flowchart illustrating execution hardware determination processing;

FIG. 9 is a diagram illustrating a calculation example of an execution hardware determination program;

FIG. 10 is a flowchart illustrating optimization processing;

FIG. 11 is a diagram illustrating an example of a user interface displayed on a console; and

FIG. 12 is a flowchart illustrating in-execution optimization processing in Modification 1.

### DESCRIPTION OF THE PREFERRED EMBODIMENTS

In this specification, electricity generated by using renewable energy is referred to as “green power”, and electricity generated by using energy other than renewable energy is referred to as “brown power”. Furthermore, the ratio between green power and brown power is hereinafter referred to as “green power ratio”. A power composition ratio takes values of from 0 to 1, for example, and 0 means that the whole is brown power, 1 means that the whole is green power, and 0.5 means that brown power and green power are 50% and 50%, respectively. For example, electricity generated by using wind power, geothermal heat, or solar light is green power, and electricity generated by using a fossil fuel is brown power. In this specification, a model obtained by optimizing a neural network model for specific hardware is referred to as “optimized model”, and an unoptimized model is referred to as “standard model”.

### Embodiment

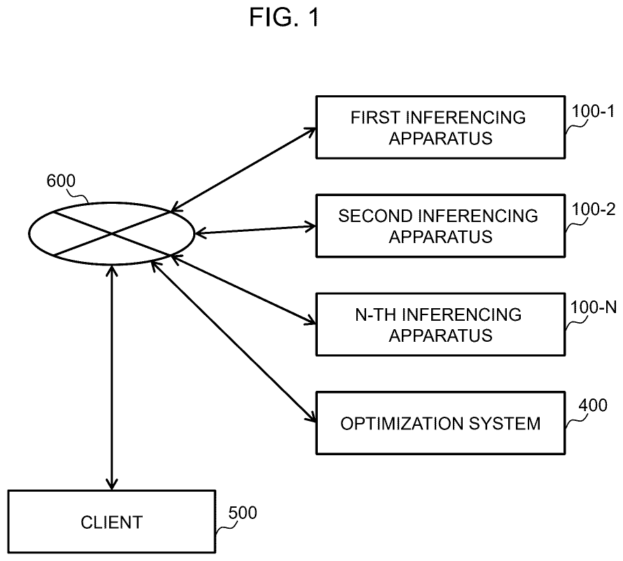

Referring to FIG. 1 to FIG. 11, an embodiment of an execution hardware determination system is described below.

FIG. 1 is an entire configuration diagram including an execution hardware determination system 400. The execution hardware determination system 400 is coupled to first inferencing hardware 100-1, second inferencing hardware 100-2, . . . , and N-th inferencing hardware 100-N and a client 500 through a network 600. Hereinafter, the first inferencing hardware 100-1, the second inferencing hardware 100-2, . . . , and the N-th inferencing hardware 100-N are collectively referred to as “inferencing hardware 100”. The pieces of the inferencing hardware 100 are different in at least one of hardware configuration, power composition ratio, and power rating. The pieces of the inferencing hardware 100 may be arranged at the same data center or may be arranged at different data centers.

The client 500 performs communication through the network 600, and transmits a user query 6000 to the execution hardware determination system 400. As described later, the user query 6000 includes a use case, performance conditions, and hardware constraint conditions. The execution hardware determination system 400 determines inferencing hardware 100 that executes a work load, and causes the inferencing hardware 100 to execute the work load. Hereinafter, the “work load” means arithmetic processing using a neural network model that is selected on the basis of the user query 6000 and optimized. Furthermore, hereinafter, hardware that is a candidate for executing a work load among the pieces of inferencing hardware 100 is referred to as “candidate hardware”, and hardware that executes a work load is referred to as “execution hardware”. The execution hardware is selected from pieces of candidate hardware.

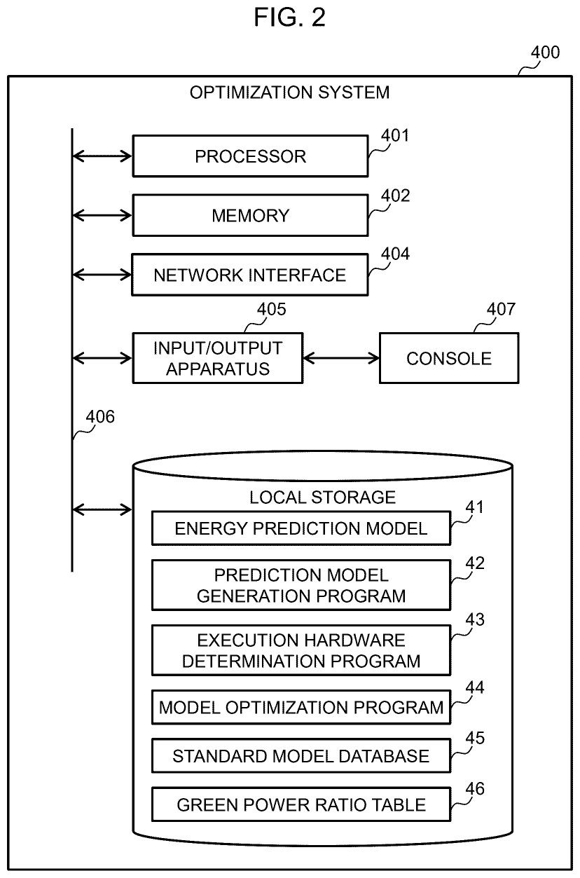

FIG. 2 is a configuration diagram of the execution hardware determination system 400. The execution hardware determination system 400 includes a processor 401, a memory 402, local storage 403, a network interface 404, and an input/output apparatus 405. Those components can mutually transmit and receive data through a system bus 406. For example, the processor 401 is a central processing unit. The memory 402 is a storage apparatus capable of high-speed reading and writing, such as a DRAM. The local storage 403 is a non-volatile storage apparatus, such as a hard disk drive. The network interface 404 is a network interface card. The input/output apparatus 405 is a display adapter.

The network interface 404 processes all communications with the outside of the execution hardware determination system 400 through the network 600. The input/output apparatus 405 provides an interface for inputting and displaying information on a console 407. The processor 401 deploys a program stored in the local storage 403 onto the memory 402, and executes the program. The processor 401 reads data stored in the local storage 403 onto the memory 402 as needed.

In the local storage 403, an energy prediction model 41, a prediction model generation program 42, an execution hardware determination program 43, a model optimization program 44, a standard model database 45, and a green power ratio table 46 are stored. The energy prediction model 41 is a neural network model that predicts in advance energy consumed when a work load is executed in each piece of inferencing hardware 100.

The prediction model generation program 42 generates the energy prediction model 41. The execution hardware determination program 43 determines execution hardware, which is hardware that executes a work load based on the user query 6000. The model optimization program 44 optimizes a neural network model for execution hardware determined by the execution hardware determination program 43, and allocates the optimized model and the work load onto the execution hardware. In the standard model database 45, data on various publicly known neural networks are stored. In the green power ratio table 46, data on a green power ratio for each data center are stored. In FIG. 2, the execution hardware determination system 400 is configured by one computer, but the execution hardware determination system 400 may be implemented by a plurality of computers operating in cooperation.

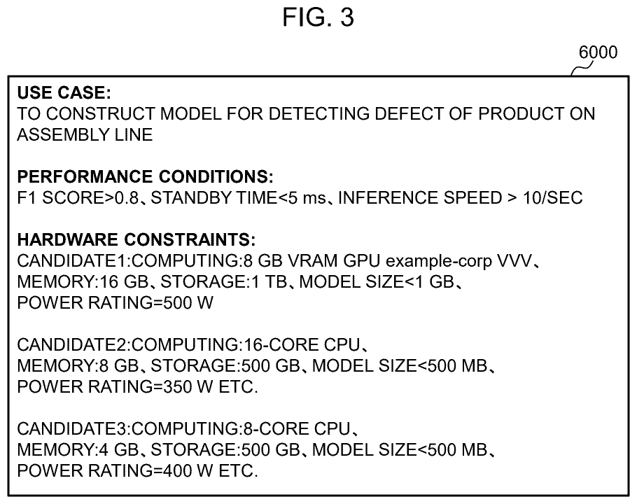

FIG. 3 is a diagram illustrating an example of the user query 6000. The user query 6000 relates to construction of a neural network model, and includes a use case, performance conditions, and hardware constraint conditions. The use case indicates use application of a neural network model to be created. The use case is, for example, “To construct a model for detecting a defect in a product on an assembly line”. The performance conditions are conditions of accuracy and performance required for inference, such as conditions that “F1 score exceeds 0.8, delay is less than 5 milliseconds, and inference speed exceeds 10/sec”.

The hardware constraint conditions are constraints of hardware that executes a neural network model to be constructed. The above-mentioned candidate hardware is hardware that satisfies the hardware constraint conditions. The “candidate” as used herein means a candidate of hardware that executes a work load based on a user query. The candidate hardware is determined by the execution hardware determination program 43. The hardware constraint conditions may include an arithmetic apparatus, a memory, storage, a model size, and power rating. Note that the hardware constraint conditions are not necessarily required to include the five conditions, and only need to include at least an arithmetic apparatus. In the example illustrated in FIG. 3, three hardware constraint conditions are written, but it is sufficient that at least one condition is written. In the example illustrated in FIG. 3, the three hardware constraint conditions are OR conditions, and it is sufficient that any one of the conditions is satisfied.

The hardware constraint condition may be designation of a condition rather than designation of a specific configuration. For example, the condition may be designated as “CPU with 8 or more cores” or “GPU with VRAM capacity of 12 GB or more”. Candidate hardware may be determined only from the contents of the user query 6000, or may be determined from other kinds of information, for example, by referring to the green power ratio table 46 and referring to specific hardware configurations. In particular, when the above-mentioned condition “CPU with 8 or more cores” is used for the hardware constraint condition, it is useful for the execution hardware determination program 43 to refer to specific configurations written in the green power ratio table 46 and set all pieces of corresponding hardware as pieces of candidate hardware.

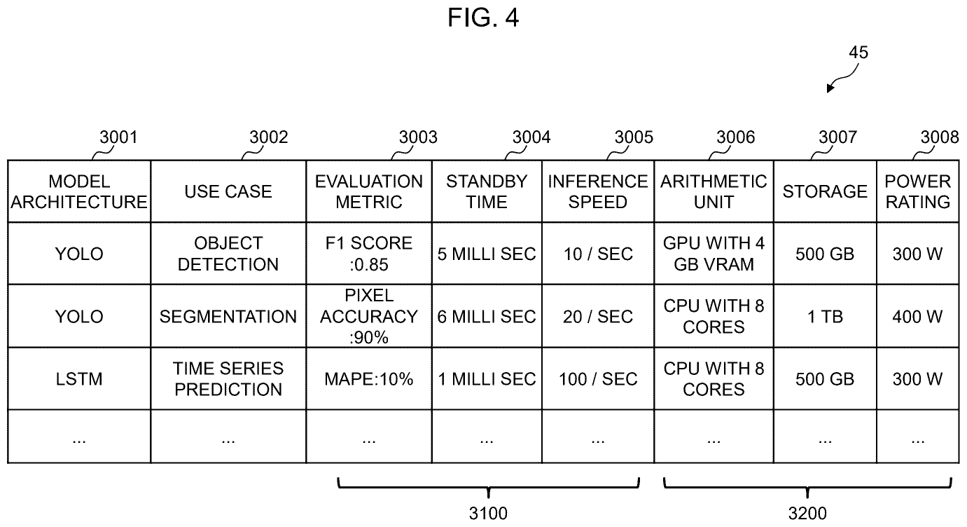

FIG. 4 is a diagram illustrating an example of the standard model database 45. In the standard model database 45, data on two or more neural networks are stored. The standard model database 45 has a plurality of records, and each record corresponds to one neural network. The specific configuration of each neural network may be included in the standard model database 45, or may be saved outside the standard model database 45. Each record in the standard model database 45 has fields of a model architecture 3001, a use case 3002, an evaluation metric 3003, a standby time 3004, an inference speed 3005, an arithmetic unit 3006, storage 3007, and a power rating 3008.

The model architecture 3001 is the name of a corresponding neural network model. The use case 3002 is a typical situation where the neural network model is used. The arithmetic unit 3006 and the storage 3007 are main specifications of an arithmetic apparatus that executes the neural network model. The evaluation metric 3003, the standby time 3004, and the inference speed 3005 are performance of the neural network model when the arithmetic unit 3006 and the storage 3007 are used.

The power rating 3008 is consumption power when the neural network model is executed by using the arithmetic unit 3006 and the storage 3007. The standard model database 45 may be manually created by an operator, or may be generated by automatic processing. Data stored in the standard model database 45 are obtained from the description of each neural network model or the Internet. Thus, variations of combinations of the model architecture 3001 and the arithmetic unit 3006 are limited.

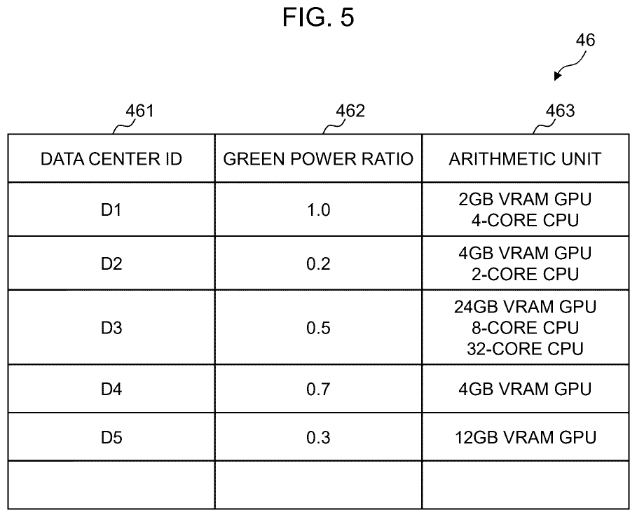

FIG. 5 is a diagram illustrating an example of the green power ratio table 46. The green power ratio table 46 is configured by a plurality of records, and each record has a data center ID 461, a green power ratio 462, and an arithmetic unit 463. The data center ID 461 is an identifier for identifying a data center. The green power ratio 462 is the ratio of green power to power supplied to the data center, and “1” means that the entire amount is green power. Data on the green power ratio 462 may be manually collected by an operator, or may be collected by automatic processing with an API. Note that, in a case where a green power ratio for each data center cannot be obtained, a green power ratio in an area where the data center is arranged may be used. The arithmetic unit 463 is a list of arithmetic hardware available at the data center. Data on the arithmetic unit 463 is obtained from a corresponding data center. The green power ratio table 46 has a field of the storage 464.

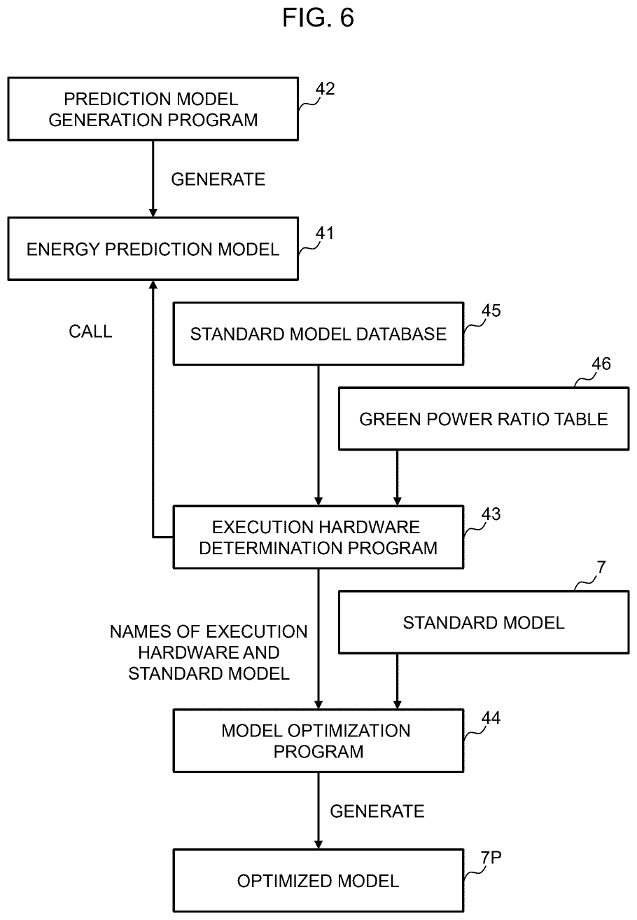

FIG. 6 is a diagram illustrating a correlation between a program and a neural network model. The prediction model generation program 42, the standard model database 45, the green power ratio table 46, and the standard model 7, which is an unoptimized neural network model, are prepared in advance. A specific example of the model architecture 3001 described in the standard model database 45 is the standard model 7. The prediction model generation program 42 generates the energy prediction model 41.

The execution hardware determination program 43 reads the standard model database 45 and the green power ratio table 46. The execution hardware determination program 43 calls and uses the energy prediction model 41 for calculation. The execution hardware determination program 43 outputs the names of the execution hardware and the standard model, which are arithmetic results, to the model optimization program 44. The model optimization program 44 optimizes the standard model 7 to the execution hardware, thereby generating an optimized model 7P.

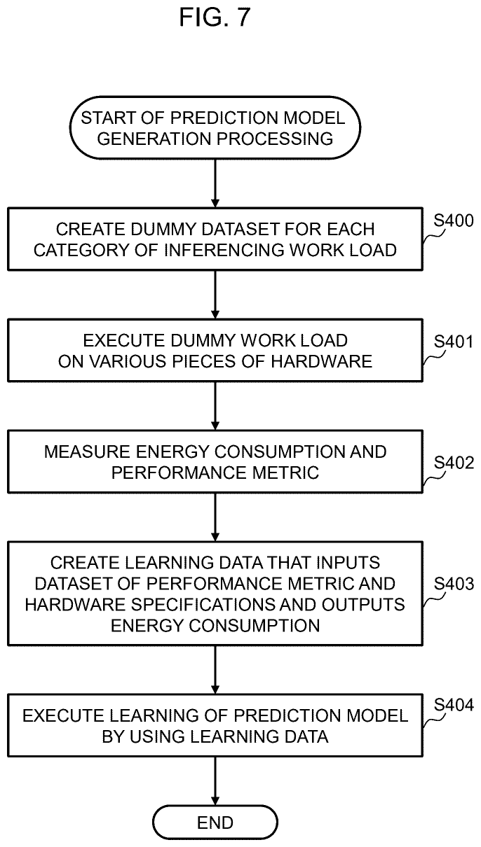

FIG. 7 is a flowchart illustrating a method for generating the energy prediction model 41 by the prediction model generation program 42. The energy prediction model 41 predicts energy that is consumed by the inferencing hardware 100 for executing a work load using a neural network model. First, in Step S400, the prediction model generation program 42 generates a dummy dataset for each category of the work load. The categories of the work load are the same as those of the use case 3002 in the standard model database 45. As a method for generating a dummy dataset, various publicly known methods can be used. Hereinafter, a work load using a dummy dataset is referred to as “dummy work load”. The number of dummy work loads is equal to the number of use cases 3002.

In subsequent Step S401, the prediction model generation program 42 lists available various hardware configurations, and executes a dummy work load by using a corresponding neural network model in a corresponding configuration. When a plurality of use cases 3002 are present for one neural network model, the neural network model executes a dummy work load for each use case 3002. The “various hardware configurations” in this step are not limited to the hardware specifications 3200 described in the standard model database 45, and include available various pieces of hardware.

The hardware may include new hardware that has not been published at the time of creation of the standard model database 45, and all pieces of hardware that are provided as virtual computers that can be accessed through the Internet and are available on demand. Available various hardware configurations specified in this step are possibly candidates of hardware that executes a work load based on the user query 6000, and hence these pieces of hardware are also candidate hardware. Furthermore, hereinafter, the processing for listing the candidate hardware in this step is sometimes referred to as “listing processing”.

In subsequent Step S402, the prediction model generation program 42 measures data on the dummy work load executed in Step S401, that is, the energy consumption amount and the performance metrics 3100 such as accuracy, F1 score, standby time, and inference speed. Hereinafter, the processing for executing a dummy work load by using candidate hardware in Step S401 and the processing for measuring the performance and the energy consumption amount in Step S402 are referred to as “measurement processing”.

In subsequent Step S403, the prediction model generation program 42 creates learning data. The learning data includes, as input data, the performance metric 3100 measured in Step S402 and the hardware specifications 3200. The learning data includes, as output data, the energy consumption amount measured in Step S402.

The types of data stored in the learning data are the same as those in the standard model database 45. However, a combination of the model architecture 3001 and the hardware specifications 3200 in the standard model database 45 is limited, but the learning data has numerous combinations. In subsequent Step S404, the prediction model generation program 42 learns the energy prediction model 41 by using the learning data created in Step S403, that is, updates the parameters of the energy prediction model 41. The above is the description of the processing illustrated in FIG. 7.

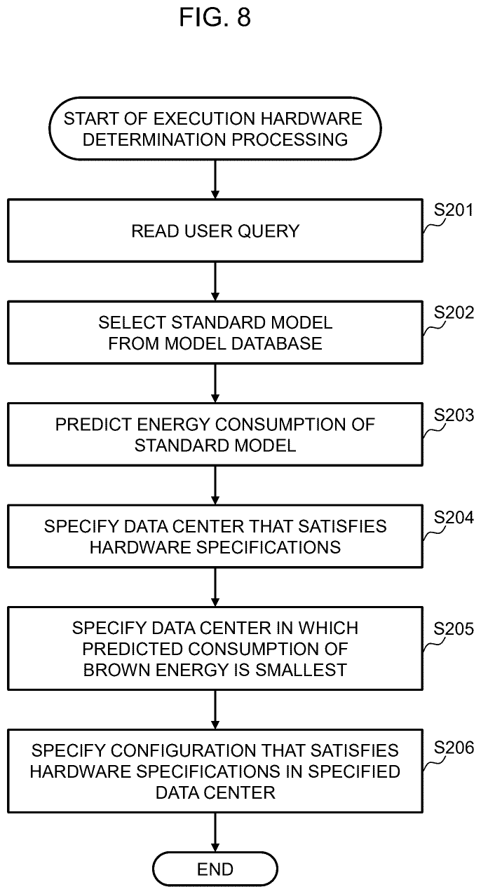

FIG. 8 is a flowchart illustrating execution hardware determination processing by the execution hardware determination program 43. First, in Step S201, the execution hardware determination program 43 reads the user query 6000. As described above with reference to FIG. 3, the user query 6000 includes a model use case, a model performance criterion, and candidate inferencing hardware constraints. The processing in Step S201 is hereinafter sometimes referred to as “query reception processing”.

In subsequent Step S202, the execution hardware determination program 43 selects a standard model that substantially satisfies the requirements written in the user query 6000 from the standard model database 45. For example, it is desired that the performance metric 3100 satisfies the value written in the user query 6000, but the execution hardware determination program 43 may select a model that does not completely satisfy the value written in the user query 6000, such as 90% or 80%. Furthermore, it is desired that the power rating 3008 be equal to or less than the value written in the user query 6000, but may be a value that exceeds the value written in the user query 6000 by 10% or 20%. The number of standard models selected in this step is 1 or more. Hereinafter, the processing in Step S202 is sometimes referred to as “search processing”.

In subsequent Step S203, the execution hardware determination program 43 uses the energy prediction model 41 to calculate consumption power of the standard model selected in Step S202. Specifically, the execution hardware determination program 43 inputs, to the energy prediction model 41 generated by the prediction model generation program 42, the performance metric 3100 written in the standard model database 45 for the selected standard model and the specifications of candidate hardware determined from the hardware constraint conditions written in the user query 6000. When there are a plurality of pieces of candidate hardware, the execution hardware determination program 43 inputs the specifications of each candidate hardware. As described above, the execution hardware determination program 43 may determine candidate hardware by referring to data in which available specific hardware configurations are written, such as the green power ratio table 46.

In this step, the execution hardware determination program 43 repeats the processing for the number of standard models selected in Step S202. For example, in a case where two standard models are selected in Step S202 and there are three pieces of candidate hardware based on the example of the user query 6000 illustrated in FIG. 3, the execution hardware determination program 43 inputs six times. Then, in this case, six values of consumption power corresponding to the six inputs are calculated. Hereinafter, the processing in Step S203 is sometimes referred to as “preliminary calculation processing”.

In subsequent Step S204, the execution hardware determination program 43 refers to the green power ratio table 46 to specify a data center that satisfies the hardware specifications 3200 written in the user query 6000. For example, in the example of the green power ratio table 46 illustrated in FIG. 5, in the case where the hardware specifications 3200 indicate “GPU with 4 GB VRAM or 8-core CPU”, data centers whose IDs are “D2” and “D3” are specified.

In subsequent Step S205, the execution hardware determination program 43 specifies a combination of hardware and a data center whose predicted consumption of brown energy is the smallest. For example, in the case where consumption power of “GPU with 4 GB VRAM” and consumption power of “8-core CPU” calculated by the energy prediction model 41 are 200 WH and 300 WH, respectively, a combination is specified as follows in the example of the green power ratio table 46 illustrated in FIG. 5.

Specifically, in a data center with an ID “D2”, the ratio of brown energy is “0.8” obtained by subtracting “0.2” from “1”, and hence brown energy of “160 WH”, which is the product of “200 WH” and “0.8”, is consumed. In a data center with an ID “D3”, the ratio of brown energy is “0.5” obtained by subtracting “0.5” from “1”, and hence brown energy of “150 WH”, which is the product of “300 WH” and “0.5”, is consumed. In other words, in this example, the data center with the ID “D3” is specified as a data center having the smallest consumption of brown energy.

In subsequent Step S206, the execution hardware determination program 43 specifies a configuration that satisfies hardware specifications at the data center specified in Step S205. For example, in the above-mentioned example, “GPU with 4 GB VRAM” is specified at the data center with the ID “D3”. Furthermore, the name or identifier of a standard model corresponding to the configuration that has been specified as having the smallest consumption amount of brown energy in Step S205 is output to the model optimization program 44 as an optimization target. Hereinafter, the processing in Steps S204 to S206 is sometimes referred to as “determination processing”. The above is the description of FIG. 8.

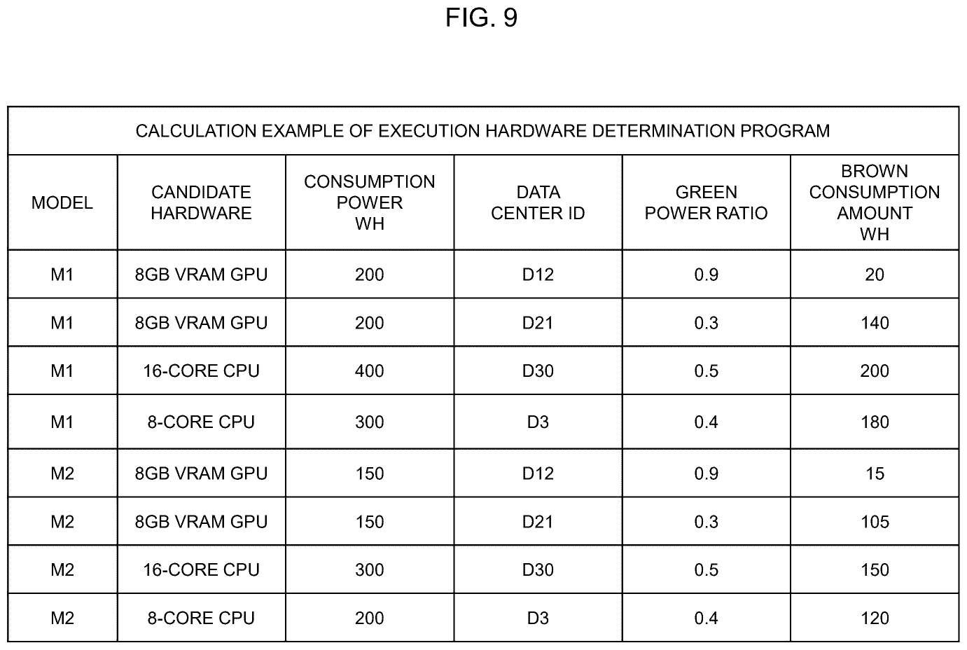

FIG. 9 is a diagram illustrating a calculation example of the execution hardware determination program 43. The example illustrated in FIG. 9 is an example of a case where there are two standard models “M1” and “M2” determined in Step S202 and three pieces of candidate hardware. Thus, in this example, the input to the energy prediction model 41 and the output of consumption power are performed six times, which is the product of 2 and 3. Furthermore, among the three pieces of candidate hardware, only one “GPU with 8 GB VRAM” is located at two places of “D12” and “D21”, and the other two pieces of candidate hardware are located only at one place.

Thus, only for the candidate hardware of “8 GB VRAM”, there are two records for the same standard model. The right end of FIG. 9 indicates the consumption amount of brown energy, and a record located at the fifth position from the top is selected as the smallest consumption amount, that is, “15 WH”. The execution hardware in this case is “GPU with 8 GB VRAM”, the standard model to be optimized is “M2”, and the data center at which a model optimized in the subsequent processing is “D12”.

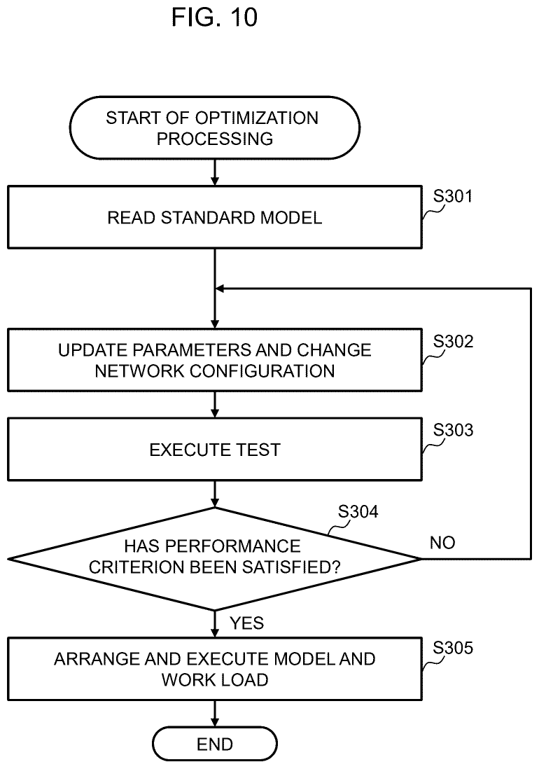

FIG. 10 is a flowchart illustrating optimization processing executed by the model optimization program 44. First, in Step S301, the model optimization program 44 reads a designated standard model. In subsequent Step S302, the model optimization program 44 performs optimization processing, that is, updates parameters and changes the network configuration. The optimization method is not particularly limited, and various publicly known methods can be used. For the optimization, model compression methods such as quantization, pruning, and knowledge distillation may be used. In subsequent Step S303, the model optimization program 44 causes the execution hardware to read the model updated in Step S302, and performs test execution using a dummy work load. In the test execution, performance is measured as well.

In subsequent Step S304, the model optimization program 44 determines whether results of the test execution in Step S303 satisfy the performance conditions written in the user query 6000. When the model optimization program 44 determines that the results of the test execution satisfy the performance conditions, the flow proceeds to Step S305. When the model optimization program 44 determines that the results of the test execution do not satisfy the performance conditions, the flow returns to Step S302, and the model optimization program 44 performs optimization again. In other words, the model optimization program 44 repeats the optimization until the performance conditions are satisfied.

In Step S305, the model optimization program 44 arranges the optimized model and the work load on the execution hardware, and starts the execution, and then the processing illustrated in FIG. 10 is finished. Hereinafter, the processing in Step S305 is sometimes referred to as “execution processing”.

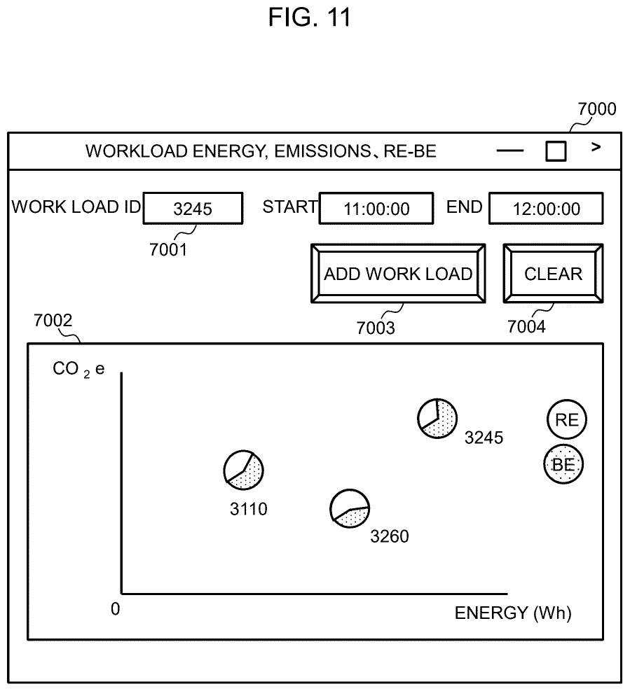

FIG. 11 is a diagram illustrating an example of a user interface displayed on the console 407. A work load display window 7000 indicates a correlation between an energy consumption amount and a consumption amount of brown energy for each of a plurality of work loads. A user query 6000 corresponding to a work load ID has been input in advance, and when an operator inputs a work load ID 7001, a start time, and an end time and then pushes a work load add button 7003, the execution hardware determination program 43 and the model optimization program 44 start the operation. Then, the optimized model optimized by the model optimization program 44 is arranged at the data center determined by the execution hardware determination program 43, and the work load is executed.

In a result display area 7002, a pie chart is displayed together with a work load ID. In each pie chart, the proportion of brown energy is indicated as a hatched region, and a total energy consumption amount of the work load is indicated as the size of a circle. Furthermore, the pie chart is located on the right side in FIG. 11 as the total energy consumption amount of the work load becomes larger, and located on the upper side in FIG. 11 as the consumption amount of brown energy becomes larger.

According to the above-mentioned embodiment, the following functions and effects are obtained.
(1) A method for determining execution hardware, which is executed by the execution hardware determination system 400, includes: the query reception processing (S201 in FIG. 8) for reading the user query 6000 in which a use case of a neural network model, a performance condition, and a constraint of candidate hardware, which is a candidate of execution hardware; the search processing (S202) for searching a model database for a standard model, which is a neural network model that satisfies most of the constraint of the candidate hardware and the performance condition; the preliminary calculation processing (S203) for inputting a performance metric of the standard model and the constraint of the candidate hardware based on the user query 6000 to the energy prediction model 41, and obtaining an energy consumption amount in the candidate hardware; and the determination processing (S206) for determining the execution hardware that executes a work load corresponding to the user query 6000 on the basis of the obtained energy consumption amount and a green power ratio, which is a proportion of renewable energy to energy supplied to the candidate hardware. Thus, hardware suitable for execution of a neural network model can be selected from the viewpoint of the consumption amount of brown energy.
(2) The processing executed by the execution hardware determination system 400 includes optimization processing, which is executed by the model optimization program 44, for generating an optimized model by optimizing the standard model to the execution hardware. Thus, a neural network model can be optimized for hardware suitable for execution of the neural network model from the viewpoint of the consumption amount of brown energy.
(3) The standard model database 45 includes a use case, model performance, and hardware specifications for each neural network model.
(4) The processing executed by the execution hardware determination system 400 includes energy prediction model generation processing, which is executed by the prediction model generation program 42, for generating the energy prediction model 41. The energy prediction model generation processing includes, as illustrated in FIG. 7, the listing processing (S401) for listing available pieces of candidate hardware, the measurement processing (S401 and S402) for executing, by using each of the listed pieces of candidate hardware, test operation using a dummy dataset and a standard model to measure the performance and the energy consumption amount, and the generation processing (S404) for generating the energy prediction model 41 in which the hardware configuration of candidate hardware and the performance measured in the measurement processing are input and the energy consumption amount measured in the measurement processing is output. Thus, the execution hardware determination system 400 can generate the energy prediction model 41 by itself.
(5) The optimization processing includes model compression technology.
(6) The processing executed by the execution hardware determination system 400 includes model database creation processing for creating the standard model database 45 by collecting data from the Internet.

### Modification 1

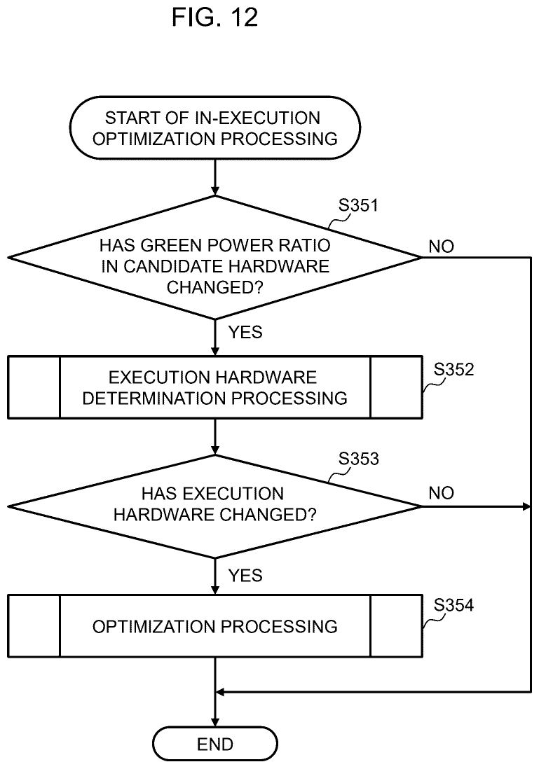

In the above-mentioned embodiment, the processing until the start of a work load has been described, but processing during the execution of a work load has not particularly been described. An in-execution optimization program may be further stored in the local storage 403 of the execution hardware determination system 400, and the in-execution optimization program may migrate a work load to another hardware during the execution of the work load. The purpose is to further reduce brown energy, and the change of the green power ratio is a trigger to operate the in-execution optimization program. The green power ratio table 46 may be manually updated by an operator. Furthermore, the green power ratio table 46 may be automatically updated by periodically executing an API for acquiring a green power ratio in an area or a facility. The in-execution optimization program executes processing illustrated in FIG. 12 periodically, for example, every 5 minutes or 1 hour.

FIG. 12 is a flowchart illustrating in-execution optimization processing for executing optimization processing again during the execution of a work load. First, in Step S351, the in-execution optimization program refers to the green power ratio table 46 to determine whether a green power ratio of candidate hardware has changed. When the in-execution optimization program determines that the green power ratio of candidate hardware has changed, the flow proceeds to Step S352, and when the in-execution optimization program determines that the green power ratio of candidate hardware has not changed, the processing illustrated in FIG. 12 is finished.

In Step S352, the in-execution optimization program causes the execution hardware determination program 43 to execute the execution hardware determination processing. In subsequent Step S353, the in-execution optimization program determines whether the execution hardware determined by the execution hardware determination program 43 has changed from the current execution hardware. When the in-execution optimization program determines that the execution hardware has changed, the flow proceeds to Step S354, and when the in-execution optimization program determines that the execution hardware has not changed, the processing illustrated in FIG. 12 is finished. In Step S354, the in-execution optimization program causes the model optimization program 44 to execute the optimization processing, and the processing illustrated in FIG. 12 is finished.

According to Modification 1, the following functions and effects are obtained.
(7) The processing executed by the execution hardware determination system 400 includes: the execution processing (Step S305 in FIG. 10) for executing an optimized model on the execution hardware; and the in-execution optimization processing (FIG. 12) for executing the determination processing and the optimization processing again when the green power ratio in the candidate hardware has changed. Thus, the execution hardware determination system 400 can reduce brown energy even when the green power ratio has changed after the start of a work load.

### Modification 2

In the above-mentioned embodiment, the execution hardware determination system 400 not only determines execution hardware but also optimizes a model. However, the execution hardware determination system 400 is not necessarily required to optimize a model, but another apparatus may optimize a model. Furthermore, the generation of a dummy dataset executed in Step S400 in FIG. 7 is not essential for the execution hardware determination system 400, and a dummy dataset created in advance may be read. Furthermore, the execution hardware determination system 400 is not necessarily required to include the prediction model generation program 42, but an energy prediction model 41 created may be read.

In each of the above-mentioned embodiment and modifications, the configurations of the functional blocks are merely an example. Some functional configurations illustrated as separate functional blocks may be integrated, or a configuration illustrated as a single functional block may be divided into two or more functions. Furthermore, a part of functions included in each functional block may be included in another functional block.

In each of the above-mentioned embodiment and modifications, the execution hardware determination system 400 may include an input/output interface (not shown), and as needed, a program may be read from another apparatus through the input/output interface and a medium that can be used by the execution hardware determination system 400. Examples of the medium as used herein include a storage medium detachably attached to the input/output interface, a communication medium, that is, a network such as a wired network, a wireless network, and an optical network, or carrier waves and digital signals that propagate through the network. Furthermore, a part or whole of functions implemented by the program may be implemented by a hardware circuit or FPGA.

The above-mentioned embodiment and modifications may be combined. While various embodiments and modifications have been described above, the present invention is not limited to those contents. Other embodiments that could be conceived within the range of the technical concept of the present invention are encompassed in the scope of the present invention.

What is claimed is:

1. An execution hardware determination method for a computer to determine execution hardware, which is hardware that executes a neural network model, the execution hardware determination method comprising:
query reception processing for reading a user query in which a use case of the neural network model, a performance condition, and a constraint of candidate hardware, which is a candidate of the execution hardware, are written;
search processing for searching a model database for a standard model, which is a neural network model that satisfies most of the constraint of the candidate hardware and the performance condition;
preliminary calculation processing for inputting to an energy prediction model a performance metric of the standard model and the constraint of the candidate hardware, based on the user query, and obtaining an energy consumption amount in the candidate hardware; and
determination processing for determining the execution hardware that executes a work load corresponding to the user query on the basis of the obtained energy consumption amount and a green power ratio, which is a proportion of renewable energy to energy supplied to the candidate hardware.

2. The execution hardware determination method according to claim 1, further comprising optimization processing for generating an optimized model by optimizing the standard model to the execution hardware.

3. The execution hardware determination method according to claim 1, wherein the model database comprises a use case, model performance, and hardware specifications, for each neural network model.

4. The execution hardware determination method according to claim 1, further comprising energy prediction model generation processing for generating the energy prediction model,
wherein the energy prediction model generation processing comprises:
listing processing for listing available pieces of the candidate hardware;
measurement processing for executing, by using each of the listed candidate hardware, test operation by using a dummy dataset and the standard model thereby measuring performance and an energy consumption amount; and
generation processing for generating the energy prediction model, in which a hardware configuration of the candidate hardware and the performance measured in the measurement processing are inputs and in which the energy consumption amount measured in the measurement processing is an output.

5. The execution hardware determination method according to claim 2, further comprising:
execution processing for causing the execution hardware to execute the optimized model; and
in-execution optimization processing for executing the determination processing and the optimization processing again when the green power ratio in the candidate hardware changes.

6. The execution hardware determination method according to claim 2, wherein the optimization processing comprises model compression technology.

7. The execution hardware determination method according to claim 1, further comprising model database creation processing for creating the model database by collecting data from the Internet.
